(19) United States
(12) Patent Application Publication
(10) Pub. No.: US 2004/0250475 A1
(43) Pub. Date: Dec. 16, 2004

(54) Door frame kit

(76) Inventor: Brian B. Seaman, Granbury, TX (US)

Correspondence Address: Guy V. Manning, 405 Park Plaza Building, 2501 Parkview Drive, Fort Worth, TX, 76102, US

(21) Appl. No.: 10/869,429

(22) Filed: Jun. 16, 2004

Related U.S. Application Data
(60) Provisional application No. 60/479,027, filed on Jun. 16, 2003.

(51) Int. Cl. E06B 3/00

(52) U.S. Cl. 49/501

(57) ABSTRACT

A door frame kit for framing an access door comprises metallic channels adapted to cover the four edges of a rectangular panel of material such as siding, sheet rock or the like. The channels include a spine which abuts the panel edge and facie which extend from the spine across a portion of the panel surface. Fingers extending from the ends of the facie portions engage the panel to grasp it, while bolts spaced along the channels draw the facie together against the panel. Corner braces cover abutting ends of channels on adjacent edges, and intermediate braces reinforce the midpoints of long channels. Means for telescopically adjusting the length of horizontal or vertical channels may be included. One or more hinges couple the spine along one edge of each resulting door section to studs framing the access opening, and lock means may attach to the spine opposite the hinge for closing and locking the door.

This is a continuation-in-part of Provisional Application No. 60/479,027, filed Jun. 16, 2003, now pending.

### BACKGROUND OF THE INVENTION

1. Field of the Invention

This invention relates generally to access doors, and particularly to access doors for storage buildings and other openings. More particularly, it relates to access doors made from material removed to create an access opening. Still more particularly, it relates to a kit adapted for framing such removed material for fabricating an access door.

2. Description of Related Art

Storage buildings made from traditional wood or wood-like materials, as opposed to metallic buildings, are constructed similarly to other frame structures. A skeleton of stud walls surrounding the storage space supports rafters and a roof, and a skin of plywood or other siding material is affixed onto the outside of the studs to enclose the space. One or more hinged access doors, commonly double doors, open outward (thus maximizing interior storage space) to provide access to the interior of the building.

Access doors often are added after the building's skin is in place. In particular, exterior siding panels are attached to studs above the stud-framed opening, and then excess material is cut away from two adjacent panels to uncover the opening. The practice improves not only the speed at which a building may be built, but also the accuracy of cutting the access opening, in contrast to cutting the panels elsewhere and adjusting them to fit. Either practice can result in waste, however, because the cut-away material may be discarded as unuseable. In the storage building trade, cost is a significant factor in market competition. Means for utilizing such surplus siding material would reduce waste and save costs of such storage buildings.

Siding material often is fragile at its edges, and it may warp or otherwise become distorted through use unless secured. When siding is attached as a skin for a building, its edges are secured and seldom subjected to significant wear. Using a cutout piece as described above for a door panel, however, is another matter. Simply attaching hinges and a lock to a flat piece of siding subjects it to edge crumble or splintering, and the unsupported panel material may warp or expand differentially. Means for protecting the edge of such material, for deterring warping and for providing an attachment structure for the door panel would significantly increase the viability of using such surplus materials for doors.

### SUMMARY OF THE INVENTION

Accordingly, it is an object of this invention to provide means for utilizing surplus siding material in construction of storage buildings.

It is another object of this invention to provide means for containing surplus siding material to prevent edge damage and to control warping when employing it as a door panel.

It is another object of this invention to provide means for surrounding the edges of a door panel as a structure for attaching it to an access opening frame.

It is yet another object of this invention to provide an aesthetically pleasing border for an inexpensive door panel.

It is yet another object of this invention to provide an adjustable kit for creating an access door from surplus siding material.

The foregoing and other objects of this invention are achieved by providing a kit for framing a portion of siding material to create an access door. The kit comprises metallic channels adapted to cover the four edges of a rectangular panel of siding material. The channels include a spine which abuts the panel edge and facie which extend from the spine across a portion of the panel surface. Fingers extending from the ends of the facie portions engage the panel to grasp it, while bolts spaced along the channels draw the facie together against the panel. Corner braces cover abutting ends of channels on adjacent edges, and intermediate braces reinforce the midpoints of long channels. Means for telescopically adjusting the length of horizontal vertical channels may be included. One or more hinges couple the spine along one edge of each resulting door section to studs framing the access opening, and lock means may attach to the spine opposite the hinge for closing and locking the door.

### BRIEF DESCRIPTION OF THE DRAWINGS

The novel features believed characteristic of the present invention may be set forth in one or more appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 depicts in perspective a storage building with the present invention in use.

FIG. 2 details in cross section as indicted on FIG. 1 a channel of the present invention integrated with the panel material and an access opening.

FIG. 3 details a corner brace structure.

FIG. 4 shows in cross section as indicated in FIG. 3 how two adjacent channels form a telescopic joint.

FIG. 5 details a mid-point brace for a channel.

FIG. 6 shows in exploded view how the several components of the present invention assemble to create a door.

FIG. 7 shows in front elevational view one access door assembled from the components shown in FIG. 6.

FIG. 8 shows an alternate embodiment of the corner brace of FIG. 3.

FIG. 9 shows an alternate embodiment of the intermediate brace corresponding to the corner brace of FIG. 8.

FIG. 10 details in cross section similar to FIG. 2 the alternate embodiment of a corner brace of FIG. 8.

FIG. 11 shows an exploded view corresponding to FIG. 6 in which the alternate braces of FIGS. 8 and 9 are employed.

### DETAILED DESCRIPTION OF A PREFERRED EMBODIMENT

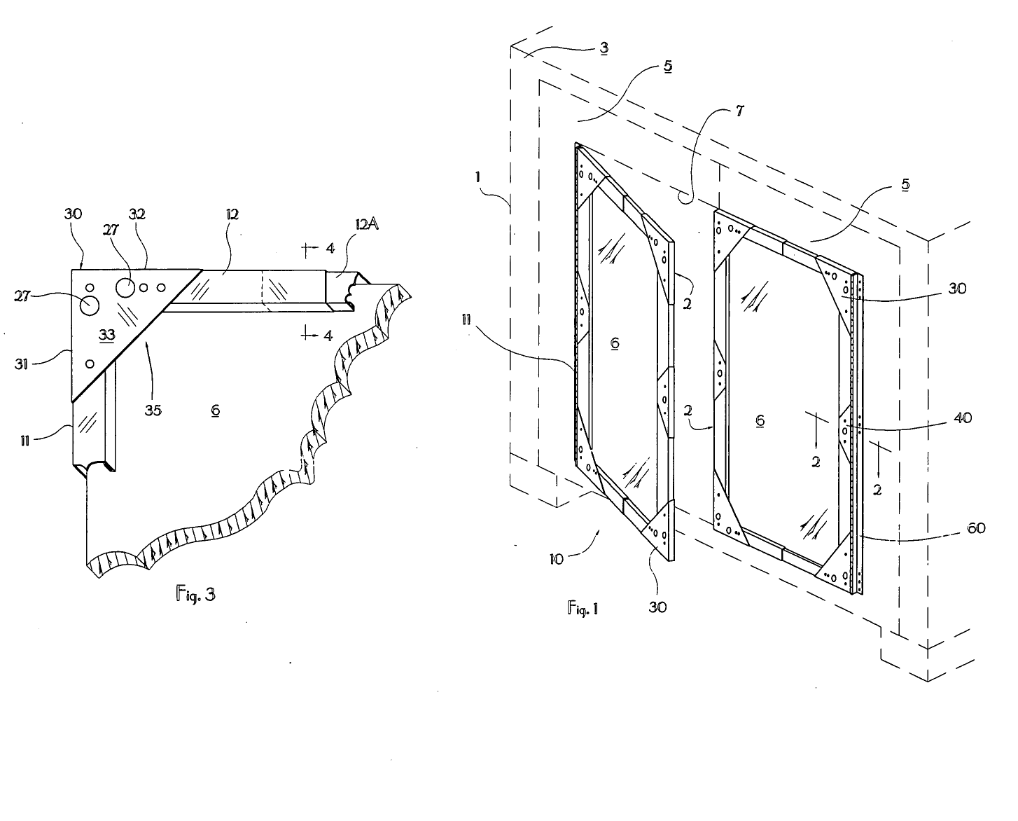

With reference now to the figures, and in particular to FIG. 1, storage building 1 is shown in phantom having stud walls (not shown) covered by skin 3 comprising sheets of siding material 5. Siding 5 typically comprises a plurality of sections of plywood or other exterior materials typically sold in four foot by eight foot (4′×8′) sheets. Access doors 2 made with door frame kit 10 of the present invention are hinged to opposite vertical door frames around access opening 7 to provide closable access through one wall to the interior of building 1.

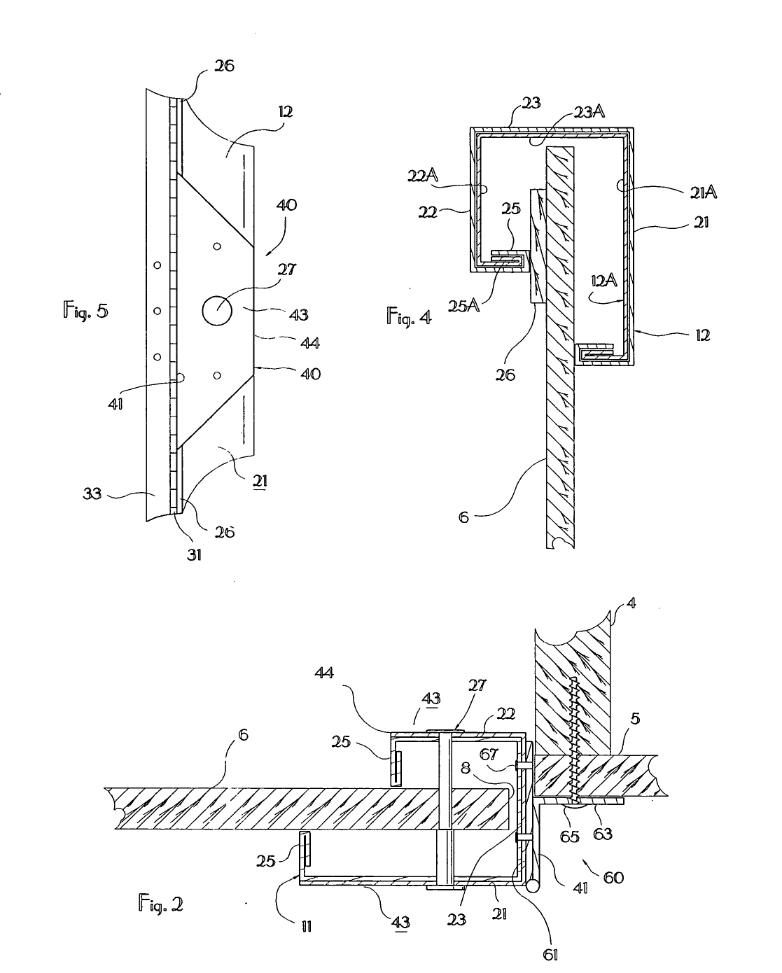

Access opening 7 is defined by studs 4 (FIG. 2) or other framing (not shown) over which two sheets of siding material 5 are attached such that their vertical edges abut at the horizontal midpoint of access opening 7. Access opening 7 then is uncovered by cutting away substantially equal portions of adjacent siding sheets 5 to create two cut-out portions, or panels 6. Access doors 2 attach as described herein to the vertical framing (not shown) around access opening 7 by hinge means 60. Absent utilizing them with kit 10 as described herein to create access doors 2, panels 6 could be hinged directly (not shown) to framing studs 4 around access opening 7 to serve as doors, or other doors could be provided and panels 6 discarded as waste. As shown in FIG. 1, however, using panels 6 with kit 10 to create access doors 2 produces doors superior to simple doors made from panels 6 alone.

Turning also now to FIGS. 2-7, door frame kit 10 comprises two each of vertical channels 11 and horizontal channels 12 abutted end to end to surround the edges of each panel 6 and braced by corner braces 30. Vertical channels 11 may be reinforced further by mid-channel braces 40, which surround channels 11 at approximately their midpoints. Channels 11 also serve as part of the structure for attaching door 2 to opening 7 using hinge means 60, as described below.

Channels 11, 12 comprise spines 23 which abut edge 8 of panel 6. Extending from both edges of spine 23, major and minor facie 21, 22 span across the front and back surfaces, respectively, of panel 6. Facie 21, 22 terminate at their opposite edges, distal spine 23, in fingers 25 which extend perpendicular to facie 21, 22 to engage the front and back surfaces of panel 6. Fingers 25 are shown fabricated of doubled wall construction to enhance their rigidity. As shown in the figures, facie 21, 22 extend to different lengths across the front and back faces of panel 6. This achieves differential bracing of panel 6, as additionally described below, with two full bracing lengths along each side and end of panel 6. One having ordinary skill in the art will recognize, however, that facie 21, 22 could be of the same length, whereby fingers 25 exert force onto front and back faces of panel 6 opposite each other.

As best seen in FIG. 2, spine 23 is substantially wider than edge 8 of panel 6, and facie 21, 22 are substantially wider than spine 23, thus giving channels 11, 12 the aesthetically desirable and recognizable appearance of conventional facie boards commonly used in building construction. The width of channels 11, 12 and the distance between fingers 25 also renders channels 11, 12 capable of embracing a variety of thicknesses of panel 6 while maintaining the same aesthetic appearance. Preferably, the separation of fingers 25 of facie 21, 22 is sized nominally to accommodate the thickness of panels 6 most typically used for skin 3, those five-eighths (⅝″) inches thick. One having ordinary skill in the art will recognize that such separation could be sized for larger or smaller thicknesses of panels 6, or, alternately, shims 26 (FIG. 4) may be used where panel 6 is smaller than the nominal spacing between fingers 25.

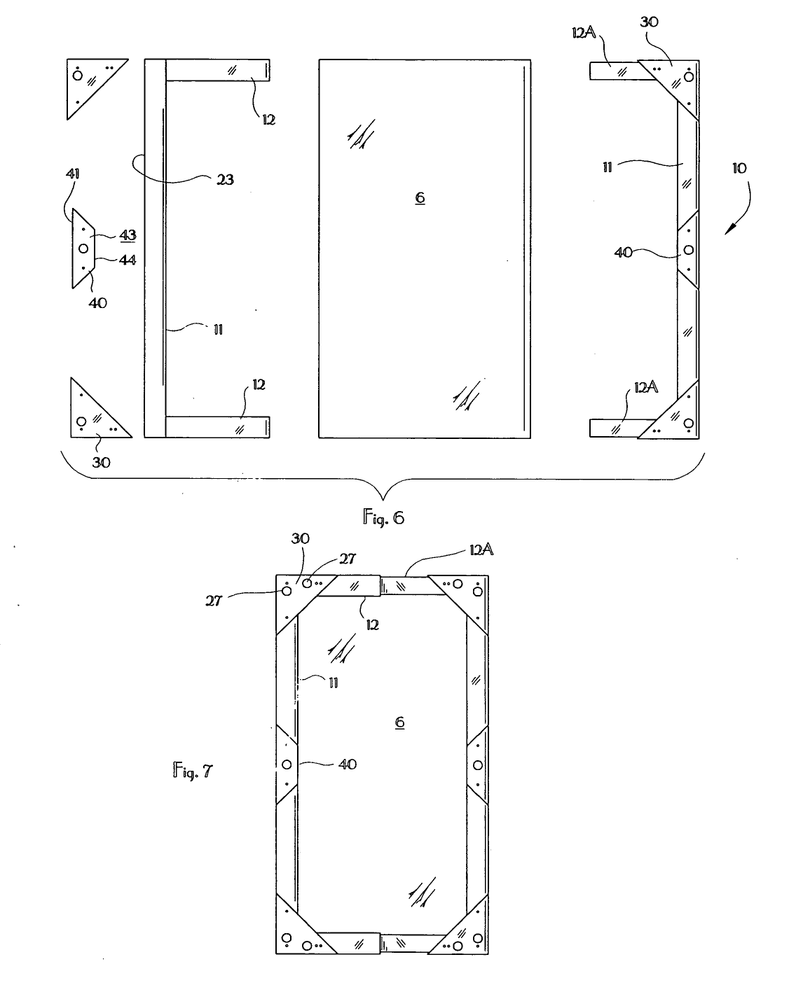

As best seen in FIG. 3, corner brace 30 comprises abutted horizontal and vertical spines 31, 32 disposed at right angles to each other and coupled together at their edges by front and back triangular faces 33 to define a triangular interior 35 of rectangular cross section. Interior 35 is adapted to receive snugly adjacent channels 11, 12 which abut at right angles near one corner of panel 6 (see also FIG. 6). Bolts 27 penetrate through both faces, channels 11, 12 and panel 6 to hold them in fixed juxtaposition, as discussed in more detail below. Four such corner braces 30 and bolts 27 secure channels 11, 12 of door frame kit 10 to panel 6, thereby creating access door 2.

As seen in FIGS. 1, 2, 5, 6 and 7, mid-channel braces 40 surround channels 11 substantially astraddle their midpoint between upper and lower corner braces 30. Each brace 40 comprises brace spine 41 that is slightly wider than spine 23 of channel 11 so that the latter may nest within the former. Two trapezoidal shaped faces 43 extend from both vertical edges of spine 41 across facie 21, 22 of channel 11 to terminate at inner edges 44 adjacent fingers 25 of channel 11. Bolt 27 penetrates both front and back faces 43 of brace 40, facie 21, 22 of channel 11 and panel 6, and faces 43 reinforce facie 21, 22 to prevent bolts 27 from crushing them. Like corner braces 30, intermediate braces 40 are fabricated from the same material as channels 11, 12, as discussed below.

Bolts 27 penetrate facie 21, 22 and panel 6, through corner braces 30, and faces 43 of mid-channel braces 40, to hold channels 11, 12 in place juxtaposed to each other and attached to panel 6. As best seen in FIG. 2, bolts 27 tighten against faces 43 through mid-channel braces 40, and likewise through facie 21, 22 of corner braces 30 (FIG. 3), to cause fingers 25 to bear against the surfaces of panel 6 with sufficient force to render channel 11, 12 quite rigid. This causes channels 11, 12 to exert a stabilizing force along the edges of panel 6 around its entire perimeter. In this fashion, channels 11, 12 embrace edge 8 and a portion of both the front and back surfaces of panel 6. Since edge 8 is enclosed entirely by channels 11, 12, it is not subject to wear, splintering or other damage. Fingers 25 bearing against opposite surfaces of panel 6 around the entire perimeter thereof exert stabilizing force to prevent warping.

One having ordinary skill in the art will recognize that the number and distribution of bolts 27 is a matter of expediency driven by the need for sufficient clamping points along the perimeter of door 2. Preferably, as seen in FIG. 7, six bolts 27 secure kit 10 to panel 6 to create door 2, except where channels 12A are employed, as discussed below. Specifically, it may suffice simply to utilize one bolt 27 for each corner brace 30 and mid-channel brace 40, even though such belt 27 cannot simultaneously penetrate both channels 11 and 12. Because channels 11 effectively bracket channels 12, a bolt through the latter likely is unnecessary, especially where heavier gauge materials are utilized for channels 11, 12. Where lighter gauge or more flexible materials are used for channels 11, 12, two such bolts 27 may be necessary. Also, where telescopic channels 12, 12A are used, as discussed below, separate bolts for channels 12, 12A may be needed.

As best seen in FIGS. 3 and 4, horizontal channels 12 may be made adjustable in length by providing a second, inner channel 12A slidably received within channel 12. This allows adjustment of the width of access door 2 for variations in the width of panel 6. For this purpose, channel 12A has the same configuration as channel 12, except that the dimensions of each component of inner channel 12A are decreased relative to the dimensions of the corresponding components of channel 12 to permit the former to telescope into the latter (FIG. 4). Specifically, spine 23A of channel 12A has an outer width slightly narrower than the inner width of spine 23 of channel 12. Likewise, facie 21A, 22A of channel 12A have outside lengths slightly shorter than the inside lengths of facie 21, 22 respectively of channel 12.

Regarding the double walled construction of fingers 25 of channel 12, the gap separating the inner and outer walls thereof is wide enough to receive between them finger 25A of inner channel 12A (see FIG. 4). Along with the reduced dimensions of channel 12A relative to channel 12 discussed above, this gap permits inner channel 12A slidably to be received inside channel 12 so that the overall length of the resulting horizontal channel 12, including channel 12A nested telescopically within channel 12 can be adjusted within the range of their respective lengths Specifically, channel 12A preferably can expand channel 12 by as much as 30% of the latter's length. For strength, preferably no more than half of channel 12A would extend out of channel 12. Thereby, channel 12 can be increased up to 30% by nesting inner channel 12A inside it and extending inner channel 12A outward from inside outer channel 12 toward opposite corner brace 30. Also, because of the slidable nature of the telescopic joint between channel 12, 12A, channels 11 do not sufficiently confine them as they would a single channel 12 of fixed length. Therefore, bolts 27 likely would be needed through corner braces 30 and channels 12, 12A (FIG. 3) in addition to using bolts 27 through vertical channels 11.

Turning again now to FIG. 2, hinge means 60 preferably comprises a piano hinge, a type of hinge providing continuous hinging connection between two objects for substantially their entire length (see FIG. 1 showing hinge means 60 extending the entire vertical length of channel 11). Hinge means 60 further comprises substantially planar first hinge member 61 attached to spine 23 of channel 11 using sheet metal screws or bolts 67 which penetrate spine 23 and mid-channel brace spine 41. Second hinge member 63 pivotally connected to first hinge member 61 comprises an “L” shape, or angled cross section so that it is adapted to mount door 2 to building 1 with greatest efficiency. Extending from its pivot point with first hinge member 61, second hinge member 63 parallels it along a portion of its width and then turns 90 degrees to extend perpendicular thereto a substantially similar distance. As seen in FIG. 2, this perpendicular portion of second hinge member 63 is adapted to abut siding 5 on building 1 so that fasteners 65 may secure hinge means 60 to studs 4 framing access opening 7. This arrangement of second hinge member 63 provides a positive attachment means better adapted to holding door 2 than just attaching it to siding 5. Hinge means 60 as described permits door 2 to swing outward from the interior of building 1 (see FIG. 1), while swinging to a closed position where first and second hinge members 61, 63 abut.

Preferably, channels 11, 12, 12A, corner braces 30 and mid-braces 40 are fabricated from sheet steel having a thickness between 26 gauge and 22 gauge. Channels 11, 12, 12A and mid-channel braces 40 may be fabricated from single, continuous sheets of steel, cold rolled or break stamped into their respective shapes. Further, channels 11, 12, 12A and mid-braces 40 alternately could be fabricated from extruded metal, such as aluminum, copper or steel, or formed in molds from thermoset plastics, without departing from the scope and or spirit of the present invention. To allow moisture to escape from the bottom of doors 2, channels 12, 12A may be provided with one or more drainage or “weep” holes (not shown) along their spines 23.

Corner braces 30, though made of similar materials, more likely would be fabricated similarly but in at least two pieces joined together. For example, corner braces 30 could be made as triangular faces 33 having spine components 31, 32 formed on the edges of faces 33 as tabs. Such tabs then would be joined together to form spines 31, 32, either fully overlapping or overlapping only enough to be riveted, brazed or otherwise joined to form spines 31, 32. One having ordinary skill in the art will recognize that alternate means of fabricating corner braces 30 may be employed without departing from the spirit and scope of the present invention. Corner braces 30 also may include decorative cutouts or shapes (not shown) along their diagonal edges, or may comprise 90 degree fittings (not shown) adapted to receive channels 11, 12, 12A within their interiors.

FIGS. 8-10 depict alternate embodiment 130 of corner braces 30 which utilize such 90 degree fittings. Corner brace 130 comprises an L-shaped gusset having face 133 that covers a portion of facie 21 of two adjacent channel members 11, 12, 12A. Spines 131, 132 extend at 90 degrees to face 133 to cover channel member spines 23, 23A. Pre-drilled into spines 131, 132 are attachment holes 136 adapted to align with similar pre-drilled holes (not shown) in channels 11, 12, 12A to permit assembly and easy insertion of attachment bolts or screws (not shown) while assembling door frame kit 10. L-shaped corner braces 130, like triangular corner braces 30, are reversible so that a single corner brace 30, 130 can fit over any of the four corners of kit 10. Attachment holes 136 thereby align with such holes in channels 11, 12, 12A regardless of orientation of corner braces 30, 130.

Further distinguishing corner braces 30, 130 is the absence of a rear face for corner brace 130 opposite front face 133. Instead, optional backing plate 137 may be utilized, if needed, to reinforce back facie 22. Backing plate 137 comprises a flat, L-shaped sheet of steel matching in area and coverage the shape of front face 133. When installed with corner brace 130, the two cover substantially all of the surface areas of facie 21, 22 and spine 23 along channels 11, 12, 12A for the length of spines 131, 132.

In contrast to the more complex fabrication method described above for corner brace 30, corner brace 130 also is considerably easier to manufacture. A flat sheet of steel having the combined width of face 133 and spines 131,132 first is bent at right angles along its length to form spines 131, 132. Then, spines 131, 132 are bent at right angles to each other to form the L-shaped structure depicted in FIG. 8.

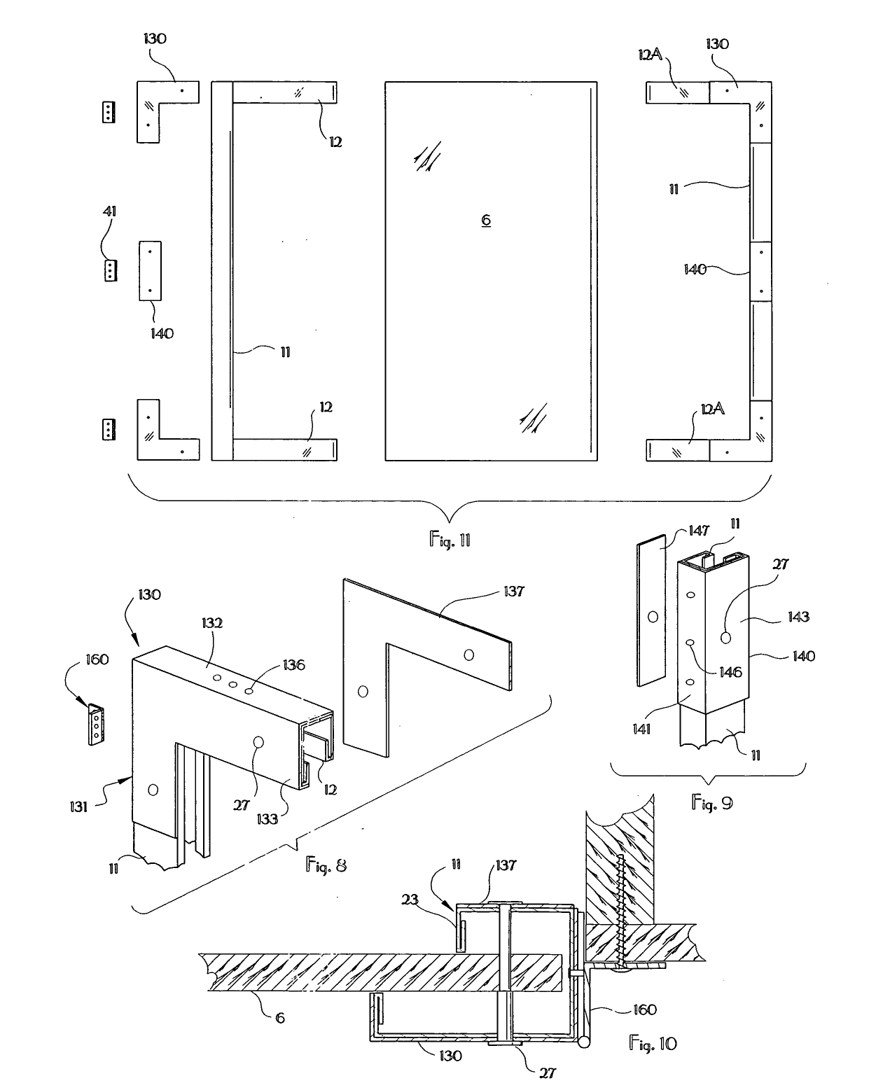

In similar fashion, an alternate embodiment 140 of intermediate brace 40 is depicted in FIG. 9 comprising front face 143 and spine 141. Face 143 covers facie 21 of channel 11 while spine 141 covers channel spine 23. Pre-drilled attachment holes 146 in spine 141 may ease attachment of brace 140 to channel 11. Bolt hole 27 is pre-drilled in brace 140 as a guide for drilling through panel 6. As with corner brace 130, no second face 143 of intermediate brace 140 covers back facie 22. Instead, if needed, intermediate backing plate 147 may be employed to reinforce facie 22. Face 143 of brace 140 also need not be trapezoidal as shown in FIG. 5, but may have square ends as depicted in FIGS. 8, 9 and 11 to match the ends of corner braces 130.

In operation, panels 6 are cut to size, whether acquired from the cut-out portion of siding 5 or otherwise. Panels 6 taken from the cut-out portion of siding 5 would be substantially ideal in size, the cutting operation having created a gap between the edge of panel 6 and the remainder of siding 5 sufficient for the thickness of spines 23 of channels 11, 12, 12A. In any case, one side of kit 10 is assembled by abutting two channels 12 to opposite ends of one channel 11 to form corner abutments which then are nested each within one corner brace 30 (see the left side of FIG. 6). Sheet metal screws then are installed to hold this assembly together while it is fitted around one side of panel 6. Holes for bolts 27 are drilled through panel 6 and bolts 27 are installed and tightened to hold the assembly to panel 6. Finally, mid-channel brace 40 is installed and bolt 27 installed through panel 6 to provide reinforcement of channel 11.

Next, a second assembly of channels 11, 12A and corner braces 30, for the opposite vertical side of panel 6, is assembled in like manner (see right side of FIG. 6), with channels 12A extending leftward toward channels 12. Mid-channel brace 40 is installed and held by retaining screws, and hinge means 60 is attached to spine 23, as discussed in more detail below. The second assembly then is placed adjacent the exposed edge 8 of panel 6 so that edge 8 abuts the inside of spine 23 thereof. To do this, the ends of channels 12A distal their corner braces 30 must be nested within the free ends of channels 12, and channels 12, 12A telescopically adjusted until a satisfactory fit between the second assembly and panel 6 is achieved. Preferably, this results in substantial overlap of channels 12, 12A, as discussed above. Once the second side is in place, holes for bolts 27 are drilled and bolts 27 are inserted through panel 6, thereby securing the second assembly to panel 6. Two such doors 2, using two kits 10 and panels 6 are in like fashion assembled to provide a closure for access opening 7.

Hinge means 60 is installed along one edge of each of the two doors 2 so assembled, as described above. Though one naturally would think in terms of installing one hinge 60 on a right edge of one door 2 and another hinge 60 on the opposite edge of the other door 2, in reality, doors 2 are symmetric about a vertical axis such that they may be installed with either end (channels 12, 12A) up. Door 2 then is positioned along the vertical edge of access opening 7, and second hinge member 63 is arrayed on the outside of siding 5 such that door 2 may swing freely between a closed position filling half of access opening 7 and an open position at least 90 degrees (perpendicular to siding 5) or more therefrom. If door 2 is a right hand door, then channels 12A would be on the right, such that hinge means 60 engages the right vertical frame of access opening 7. If door 2 is to be a left-hand door, then it first is inverted so that channels 12A are on the left side of door 2 and hinge means 60 engages the left vertical frame of access opening 7. In both cases, second hinge member 63 is secured through siding 5 using screws 65, making sure they penetrate into framing materials such as studs 4 supporting siding 5. In this fashion, doors 2 are well secured to building 1, especially in contrast to smaller hinges which may be secured to siding 5 alone. One having ordinary skill in the art will recognize, too, that hinge means 60 is not confined to the preferred continuous piano hinge arrangement described, but also could include a plurality of individual hinges attached along spine 23 of channel 11 as needed for the circumstances and weight and size of door 2 involved.

Where alternate corner braces 130 and intermediate braces 140 are employed, a variation on the above procedure occurs. Corner braces 130 are attached, two each to opposite ends of first and second channel members 11 using attachment bolts 67 through pre-drilled holes 136 in spine 131. For channels 11 serving as the hinged side of door 2, bolts 67 also may secure hinges 160 in place, as depicted in FIGS. 8 and 10. Similarly, intermediate braces 140 are bolted to spines 23 of channel members 11, with hinge 160 attached to one of the two channels 11. Next, two channels 12, 12A are attached to corner braces 130 using pre-drilled holes in spines 132 and channels 12, 12A. Next, first channel 11, with channels 12 and corner braces 130 attached, are mated to panel 6, and pilot holes for bolts 27 may be drilled an bolts 27 inserted. Next, second channel member 11 in like fashion is secured to the opposite vertical edge of panel 6, telescopically assembling channels 12, 12A as discussed above. Pilot holes through panel 6 for bolts 27 are drilled and bolts 27 inserted to affix second channel member 11 to panel 6. Pilot holes and bolts 27 through intermediate braces 140 on both channels 11 then may be installed, using backing plates 147 if needed. Bolts 27 then are tightened around the perimeter of door 2 to cause fingers 25 to bear against panel 6, using backing plates 137 if needed to reinforce facie 22.

The present invention, described in either its preferred or alternate embodiment, thus serves to fabricate doors 2 from siding material 5, in particular cut-out panel 6 which otherwise might be discarded as waste. Doors 2 provide positive closure to building 1 while displaying an aesthetically pleasing appearance resembling much more expensive and heavy doors. Kits 10 can be standardized for nominally expected skin 3 siding materials 5 and inventory simplified. The expense of separately fabricated or purchased doors for access opening 7 can be avoided, thereby reducing costs and boosting profitability.

While the invention has been particularly shown and described with reference to one or more embodiments, it will be understood by those skilled in the art that various changes in form and detail may be made therein without departing from the spirit and scope of the invention. For example, channels 12, 12A have been represented as a telescoping width adjustment for doors 2, but a similar height adjustment could be achieved by providing such telescoping adjustment in channels 11. Further, this vertical telescopic adjustment could be enclosed beneath mid-brace 40 and rendered unobtrusive or invisible. Alternately, the horizontal width of door 2 could be fixed by simply using one channel 12 and omitting the telescopic joint that requires nested channel 12A. Though hinge 60 has been discussed as a continuous piano hinge, it could be several individual hinges, as shown in FIG. 11. Though the invention has been described as applied to wood panels 6 to be used as access doors for building 7, kits 10 could be used with comparable or even greater effectiveness for much smaller doors through other wall materials, such as sheet rock, which could not be used for doors 2 without protective framing such as kit 10. Further, panel 6 has been described as planar, but panel 6 could just as well comprise irregular surfaced materials such as corrugated steel or fiberglass. Finally, though kits 10 have been shown and described as fitted to rectangular doors 2 having four corners with 90 degree included angles between their side and top edges, kits 10 could include channel members 11, 12, 12A for doors having any number and sizes of edge segments, with pairs of adjacent edge segments having included angles greater or less than 90 degrees (e.g. octagonal doors, not shown, with equal edge segments and 60 degree included angles). Corner braces having corresponding included angles between their spines 31, 32 or 131, 132, and correspondingly adapted faces 33, 133, would be provided.

I claim:

1. A door framing system, the door adapted to provide closeable access to an enclosure, the door being defined by a series of linear edge segments arrayed end-to-end around a panel, the panel having a front face and an opposing back face, each pair of adjacent edge segments defining an included angle, the door framing system comprising
a plurality of channel members each substantially the length of a panel edge segment and having a channel recess, the channel members adapted to receive a panel edge segment within its channel recess;
a plurality of corner braces adapted to couple together each of two adjacent channel members;
fasteners for securing the channel members and corner braces to the panel; and
hinges disposed on one of the channel members.

2. The door framing system according to claim 1 and further comprising
mid-channel braces on one or more of the channel members.

3. The door framing system according to claim 1 wherein the channel members further comprise
a spine extending the length of the channel member and adapted to abut the panel edge;
major and minor facie members extending from the spine across a portion of the front and back faces respectively of the panel; and
fingers disposed on the facie members distal the spine and extending to the panel faces.

4. The door framing system according to claim 1 wherein the corner braces comprise
two brace spines coupled end-to-end at an angle matching an included angle; and
one or more faces extending perpendicular to and between the brace spines to cover a portion of each channel.

5. The door framing system according to claim 4 wherein
two corner brace faces extend between the brace spines, one on either side of the panel; and
the brace spines and faces form a pocket adapted to surround a corner of the panel and an abutment of two adjacent channel members.

6. The door framing system according to claim 4 wherein the corner brace faces further comprise
triangular plates having two sides mated with edges of the spines and a third edge extending between ends the spines distal the included angle.

7. The door framing system according to claim 6 wherein the corner brace faces further comprise
decorative shaping of the third edge of the plate.

8. The door framing system according to claim 4 wherein
a single corner brace face extends between the spines to cover a portion of the front face of the panel and an abutment of two adjacent panel members.

9. The door framing system according to claim 8 and further comprising
a backing plate disposed over the rear face opposite the single face.

10. The door framing system according to claim 1 wherein the fasteners comprise
longitudinally adjustable flange bolts journaled within apertures extending coaxially through the panel, the corner braces and at least one channel member.

11. The door framing system according to claim 1 wherein the hinge means comprises
a plurality of hinges disposed at intervals along the channel spine and having
a spine attachment leg juxtaposed to and coupled to the channel spine; and
an enclosure attachment leg coupled to the spine attachment leg by a swivel and having
a first hinge segment disposed proximate the swivel and
a second hinge segment disposed perpendicular to the first hinge segment distal the swivel and adapted to extend away from the spine attachment leg to couple to the enclosure.

12. The door framing system according to claim 1 wherein the hinge means comprises
a piano hinge extending continuously the length of the channel member

13. The door framing system according to claim 1 wherein one or more of the channel members further comprises
telescoping means for telescopically adjusting its length to match the panel segment.

14. The door framing system according to claim 13 wherein the telescoping means comprises
an outer channel segment having a first spine width and double walled fingers defining a slot; and
an inner channel segment having a second spine width less than the first spine width and adapted to telescopically nest within the recess of the outer channel segment with its finger nested within the slot.

15. A door frame kit adapted to create a door, the door comprising a rectangular panel having four corners and front and back faces separated by panel edges, the door adapted to be hingedly affixed within a door opening, the door frame kit comprising
two vertical channel members and two horizontal channel members, each adapted to receive an edge of the panel within a channel recess defined by
a channel spine paralleling the panel edge;
two facie members extending one on each side of the panel from the channel spine to cover a portion of the front and back panel faces respectively;
fingers disposed on the facie members distal the spine and extending toward the panel faces;
four corner braces, each disposed on one corner of the panel over two-adjacent channel members;
a plurality of flange bolts penetrating the corner braces, at least one of the channel members and the panel; and
a plurality of hinges disposed along the spine of one of the channel members and adapted to couple the door to the door opening.

16. The door framing system according to claim 15 wherein at least two of the channel members further comprise
an outer channel segment having a first spine width; and
an inner channel segment having a second spine width and adapted to telescopically nest within the recess of the outer channel segment.

17. An improved method of fabricating a storage building door, the storage building having a plurality of frame members defining a plurality of walls and supporting a skin having a thickness, the method comprising
providing a door frame kit having
two vertical and two horizontal channel members, each having a channel spine, two facie members extending from opposite edges of the channel spine, and fingers disposed on the facie members distal the spine and extending toward the other facie member to terminate a distance apart approximately equal to the skin thickness;
four corner braces having vertical and horizontal spines and at least one face extending between the spines;
a plurality of flange bolts; and
a plurality of hinges;
selecting a position in one of the storage building walls for the door; then
cutting at least one planar panel from the skin of the wall to expose an opening for the door, the planar panel having front and back faces separated by two vertical and two horizontal edge segments; then
erecting a door frame around the door opening;
inserting the vertical edges of one side of the planar panel into a first one of the vertical channel members between the fingers until the panel edge abuts the channel spine; then
placing two corner braces over the upper and lower extremities of the first vertical channel member and adjacent corners of the panel and aligning pre-drilled holes in the corner spines and the channel members; then
securing one or more hinges to the corner brace spines and the first vertical channel member using hinge bolts;
inserting the horizontal edges of the panel into the horizontal channel members and abutting the horizontal channels to the first vertical channel member; then
securing the horizontal channel members to the corner spines using sheet metal screws; then
inserting the opposite vertical edge of the panel into a second vertical channel member and abutting the horizontal channel members thereto; then
placing two corner braces over upper and lower extremities of the second vertical channel member and securing the corner braces to the horizontal and second vertical channel members using sheet metal screws; then
drilling holes through the corner braces, channels and the panel and affixing them together with the flange bolts; then
attaching the hinges to the storage building door frame.

18. The improved method of fabricating a storage building door according to claim 17 and further comprising the steps of
providing a telescopic joint in the horizontal channel members having
an outer channel segment having a first spine width; and
an inner channel segment having a second spine width and adapted to telescopically nest within the recess of the outer channel segment; then
including the additional steps of
inserting the horizontal panel edges into the outer channel segments abutting the first vertical channel and securing them to the corner braces secured to the first vertical channel using sheet metal screws; then
inserting the horizontal panel edges into the inner channel segments; then
nesting the inner channel segments telescopically into the outer channel segments; then
adjusting the inner channel segments telescopically to a abut the second vertical channel member; then
securing the inner channel segments to the corner braces secured to the second vertical channel member.

19. An improved method of fabricating an access door, the access door adapted to provide closure and access through an opening, the opening having frame members surrounding it and adapted to have the door hingedly attached thereto, the method comprising
providing a panel substantially the size and shape of the opening, the panel being defined by a series of linear edge segments surrounding planar front and rear surfaces;
providing a door frame kit having
two vertical and two horizontal channel members, each having a channel spine, two facie members extending from opposite edges of the channel spine, and fingers disposed on the facie members distal the spine and extending toward the other facie member to terminate a distance apart approximately equal to the skin thickness;
four corner braces adapted to cover two adjacent channel members;
a plurality of flange bolts; and
a plurality of hinges;
selecting a position in one of the storage building walls for the door; then
cutting at least one planar panel from the skin of the wall to expose an opening for the door, the planar panel having front and back faces separated by two vertical and two horizontal edge segments; then
erecting a door frame around the door opening;
inserting the vertical edges of the planar panel into the vertical channel members between the fingers; then
inserting the horizontal edges of the panel into the horizontal channels abutting the vertical channels; then
placing the corner braces over the corners of the panel and covering the ends of adjacent abutting channel members; then
drilling holes through the corner braces, channels and the panel and affixing them together with the flange bolts; and
attaching the hinges to one of the channel members; then
attaching the hinges to the door frame.
